(19) United States
(12) Patent Application Publication
(10) Pub. No.: US 2023/0234782 A1
(43) Pub. Date: Jul. 27, 2023

(54) METHOD AND SYSTEM FOR RETRIEVING AND STORING ITEMS WITHIN AT LEAST ONE HIGH DENSITY RACKING STRUCTURE

(71) Applicant: Amir KHAJEPOUR, Waterloo (CA)

(72) Inventor: Amir KHAJEPOUR, Waterloo (CA)

(21) Appl. No.: 18/051,560

(22) Filed: Nov. 1, 2022

Related U.S. Application Data
(60) Provisional application No. 63/275,118, filed on Nov. 3, 2021.

(51) Int. Cl. B65G 1/137; B65G 1/04; B65G 1/06

(52) U.S. Cl. CPC B65G 1/137; B65G 1/0478; B65G 1/06; B65G 2201/0258

(57) ABSTRACT

The disclosure is directed at a high-density warehousing system that includes a set of high-density racking structures, each of the high-density racking structures including a set of compartments for housing a set of bins. The system can also include an automated picker for retrieving a requested bin or returning a returned bin to a designated compartment within the set of high-density racking structures and a control system for communicating compartment location information, the compartment location information associated with the designated compartment. Based on the compartment location information, the automated picker retrieves or returns the bin to the designated compartment.

### CROSS-REFERENCE TO OTHER APPLICATIONS

The current disclosure claims priority from United States Provisional Patent Application No. 63/275,118 filed Nov. 3, 2021, which is hereby incorporated by reference.

### Field

The disclosure relates in general to warehousing, and, in particular, to a method and system for retrieving and storing items within at least one high-density racking structure.

### BACKGROUND

With the increase of online shopping or e-commerce, storage space for consumer products is at a premium. In order to increase storage capacity, different solutions have been developed.

Modern warehouses store a variety of products grouped as individual items in standardized bins. The number of items stored in a warehouse, and the throughput of items that must be delivered from the warehouse, may vary widely from one use case to the next. In general, there is a tradeoff in the design and operation of a warehouse between use cases requiring high throughput versus use cases requiring storage of a large number of items. A high throughput use case may benefit from a low-density racking structure for items in bins while a large number of items use case may benefit from a high-density racking structure. Conventional racking structures, either low- or high-density, do not scale well with the number of items and become highly inefficient with regard to the space they occupy, their throughput, their efficient use of automated picking mechanisms, or some combination thereof. There is currently an unmet need for a high-density racking structure that scales efficiently with the number of items stored.

Therefore, the disclosure is directed at a method and system for retrieving and storing items within at least one high-density racking structure.

### SUMMARY

In select embodiments, the present disclosure provides a high-density storage warehousing system including an automated picker, a dynamic racking structure, and a controller. In one embodiment, the controller is configured to provide instructions to the picker and to the dynamic racking structure with respect to a specified, predetermined, or requested bin or item. The dynamic racking structure is configured to prepare a bin handler for transfer of the requested bin or item between the dynamic racking structure and the automated picker. The automated picker is configured to perform the transfer of the requested item between the dynamic racking structure and the automated picker. Transferring of an item or bin may include passing of the item or bin from the racking structure to the picker or vice-versa.

In select embodiments, the present disclosure provides a method for picking or storing an item in a high density storage warehouse. The method includes receiving a request for an item. The method includes transmitting instructions to a processor associate with a dynamic racking structure to prepare a bin handler for transfer of the requested item and transmitting instructions to an automated picker to transfer the requested item.

In one aspect of the disclosure, there is provided a high-density warehousing system including a set of high-density racking structures, each of the high-density racking structures including a set of compartments for housing a set of bins; an automated picker for retrieving a requested bin or returning a returned bin to a designated compartment within the set of high-density racking structures; a control system for communicating compartment location information, the compartment location information associated with the designated compartment; wherein based on the compartment location information, the automated picker retrieves or returns the bin to the designated compartment.

In another aspect, the control system includes an automated picker controller for communicating with the automated picker; and a bin location controller. In a further aspect, the compartment location information is transmitted via the automated picker controller to the automated picker. In yet a further aspect, each of the set of compartments comprises a bin handling system for changing positions of bins within the compartment and a bin handling system controller. In another aspect, the bin location controller transmits bin information associated with the requested bin or the returned bin to the bin handling system controller. In a further aspect, the bin handling system controller controls the bin handling system to position the requested bin at an opening of the designated compartment for retrieval by the automated picker or to position an empty slot at the opening of the designated compartment for receiving the returned bin from the automated picker.

In another aspect, each of the set of compartments includes a bin handling system for changing positions of bins within the compartment. In an aspect, each of the set of racking structures comprises a racking structure controller. In yet another aspect, the bin location controller transmits bin information associated with the requested bin or the returned bin to the bin racking structure controller. In another aspect, the racking structure controller controls the bin handling system of the designated compartment to position the requested bin at an opening of the designated compartment for retrieval by the automated picker or to position an empty slot at the opening of the designated compartment for receiving the returned bin from the automated picker.

### BRIEF DESCRIPTION OF THE DRAWINGS

The foregoing and other features and advantages of the disclosure will be apparent from the following description of embodiments thereof as illustrated in the accompanying drawings. The accompanying drawings, which are incorporated herein and form a part of the specification, further serve to explain the principles of the disclosure and to enable a person skilled in the pertinent art to make and use the disclosure. The drawings are not to scale.

FIG. 1a is a side view of a low density racking structure;

FIG. 1b is a front perspective view of the low density racking structure of FIG. 1A with one rack removed for clarity;

FIG. 2 is a front perspective view of a dynamic racking structure according to an embodiment herein;

FIG. 3 is a front perspective view of the dynamic racking structure of FIG. 2 equipped with an automated picker;

FIG. 4 is a cross-sectional view of a bin handler of FIG. 2 along plane A of FIG. 2;

FIG. 5 is a front perspective view of a bin handler according to an embodiment herein;

FIG. 6 is a front perspective view of the automated picker of FIG. 3;

FIG. 7 is a front perspective view of a first arrangement of dynamic racking structures;

FIG. 8 is a top view of the first arrangement of dynamic racking structures of FIG. 6;

FIG. 9 is a front perspective view of a second arrangement of dynamic racking structures;

FIG. 10 is a top view of the second arrangement of dynamic racking structures of FIG. 8;

FIG. 11 is a schematic diagram of another embodiment of a high density warehousing system;

FIG. 12a is a flow diagram of one method for operating a dynamic racking structure; and

FIG. 12b is a flow diagram of another method for operating a dynamic racking structure.

### DETAILED DESCRIPTION

Specific embodiments of the present disclosure are now described with reference to the figures wherein like reference numbers indicate identical or functionally similar elements. The following detailed description is merely exemplary in nature and is not intended to limit the disclosure or the application and uses of the disclosure. Directional terms used within the specification are with respect to the way in which the drawing is presented unless otherwise described. Furthermore, there is no intention to be bound by any expressed or implied theory presented in the preceding technical field, background, brief summary or the following detailed description.

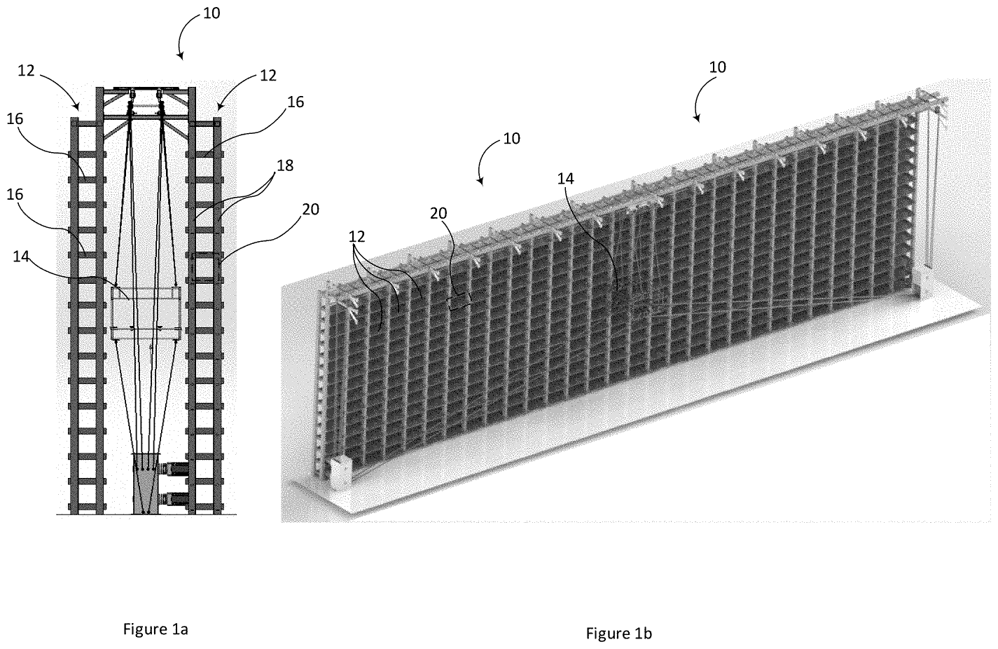

Turning to FIG. 1a, a side view of a prior art low-density racking structure is shown while FIG. 1b is a front perspective view of the racking structure of FIG. 1a. The low-density racking structure 10 includes a set of racks 12 and an automated picker 14, such as, but not limited to, a warehousing robot. For clarity and ease of view, one of the set of racks has been removed in FIG. 1b. Each rack 12 includes a plurality of shelves 16 that are supported by a plurality of load beams 18. In FIGS. 1a and 1b, only some of the shelves 16, load beams 18 and compartments 20 are labelled.

The shelves 16 and load beams 18 divide the rack 12 into an array of compartments 20 that houses bins to store or hold different or the same items. The compartments are open on a side adjacent the automated picker 14 such that the bin that is in a specific or designated compartment may be retrieved by the automated picker 14 and vice-versa where the bin is stored or placed by the picker 14 back into the compartment 20.

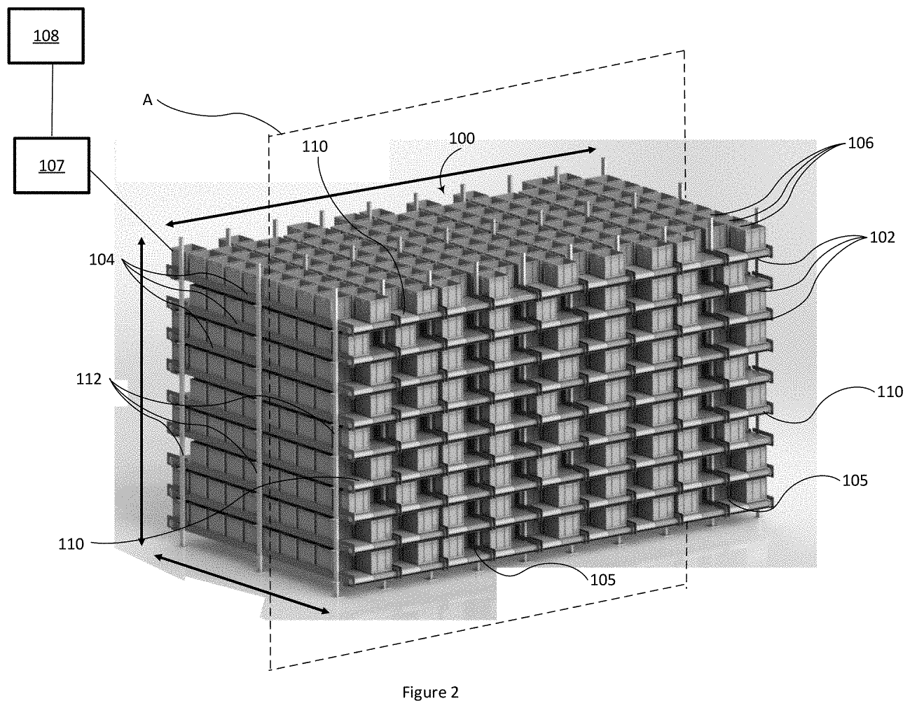

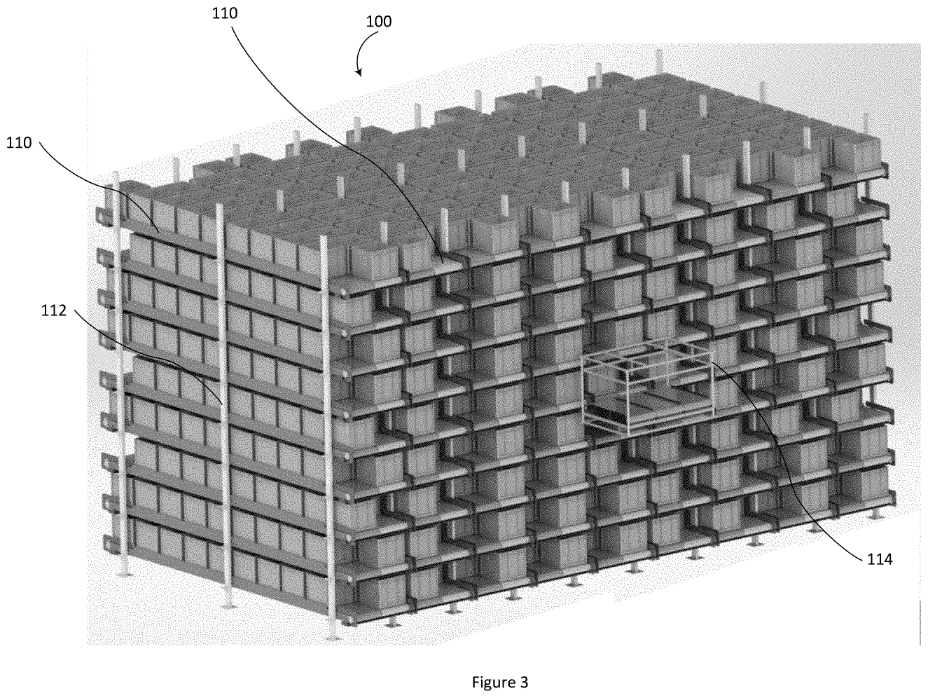

FIG. 2 is a front perspective view of a dynamic high-density racking structure 100 according to an embodiment herein. In FIG. 2, select examples of the shelves 102, dividers 104, bins 106, bin handlers 110 and load beams 112 are labelled for clarity. FIG. 3 is a front perspective view of the dynamic racking structure 100 equipped with an automated picker 114 such as, but not limited to, a warehousing robot.

The dynamic high-density racking structure 100 includes a set of shelves 102 (supported by load beams 112) that include dividers 104 that define compartments 105 for housing or storing a set of at least two bins. Each compartment 105 also includes bin handlers 110 or a bin handling apparatus for moving the set of at least two bins within the compartment 105. This will be discussed in more detail below.

Each compartment 105 is designed to house the set of at least two bins 106 with each bin 106 storing quantities of a specific item. The associated bin handler 110 is used to position the set of at least two bins 106 within the compartment 80 for retrieval or return from an automated picker, such as a warehousing robot (not shown).

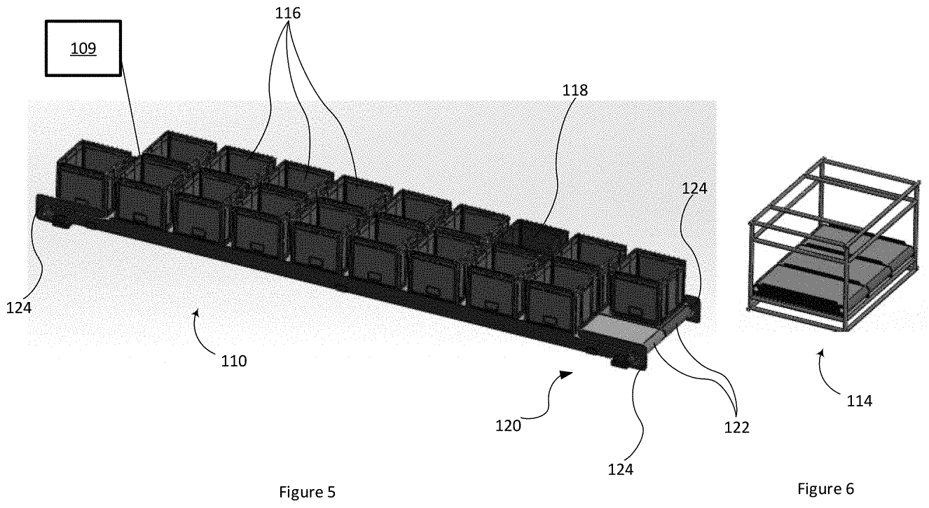

In the current embodiment, the dynamic high-density racking structure 100 includes a racking structure controller 107 that is associated with the high-density racking structure 100. In one embodiment, the racking structure controller may be a processor that controls the operation of the racking structure. For example, the racking structure controller 107 may control each bin handling apparatus to position a requested or designated bin at an opening of the compartment or to position a slot at the opening of the compartment for receiving a returned bin when instructed by a warehousing controller 108. The warehousing controller 108 may receive input (in the form of a request) for retrieval of a bin from a compartment or for return of a bin to a compartment. The warehousing controller 108 may then instruct the automated picker to travel to the designated compartment (the compartment associated with the bin) and to communicate with the racking structure controller 107 to position the designated bin or a slot for receiving the returned bin at an opening of the designated compartment. In other embodiments, the racking structure controller 107 may communicate with individual bin handling apparatus controllers that are associated with each individual compartment to position the at least two bins accordingly or the racking structure controller 107 may be implemented as individual bin handling controllers 109 (as shown and discussed in FIG. 5) associated with each individual compartment. In other embodiments, the warehousing controller 108 may communicate the request to the racking structure controller 107 and the racking structure controller 107 controls the automated picker to retrieve or return the bin to the designated compartment. The warehousing controller 108 and the racking structure controller 107 and any other controllers, such as, but not limited to, the individual bin-handling controllers, may be implemented via hardware, software or firmware.

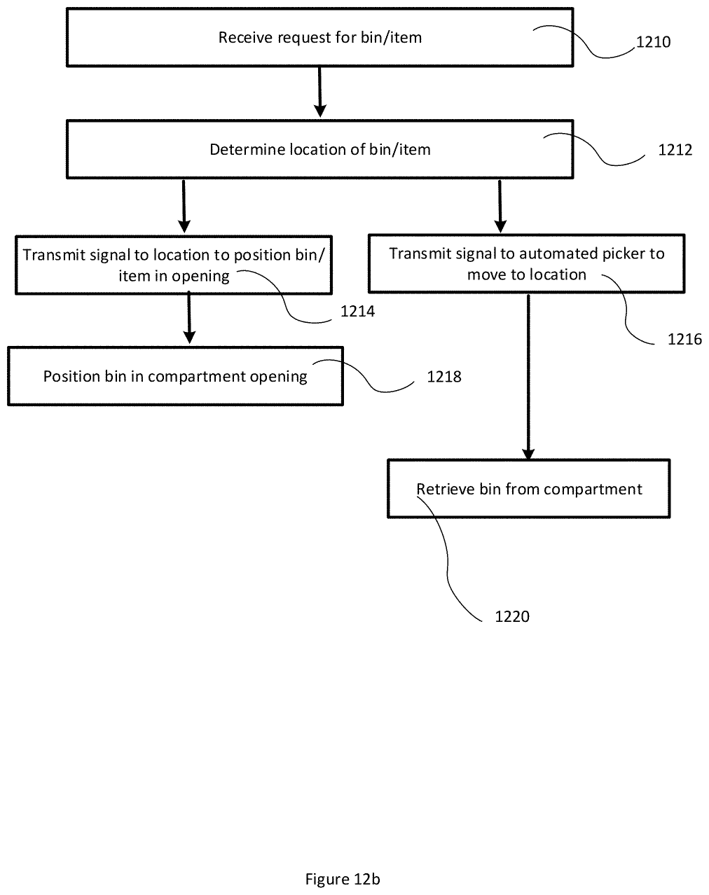

In one embodiment of use or operation, such as schematically shown in FIG. 12a, the warehousing controller 108 receives an input such as in the form of a request. The request may be for the retrieval of a bin (or retrieval of an item from a bin) or a return of a bin (or a return of an item to a bin) to a designated compartment (1200). In some embodiments, the warehousing controller may only receive bin or item information and then determines the designated compartment where the bin or item is located. This may also be performed by the racking structure controller or a bin handling controller. After receiving the input (which depending on a design of the system may or may not be part of the method of the disclosure), instructions are received by the racking structure to position the set of at least two bins in the designated compartment accordingly (1202). The warehousing controller or the racking structure controller may also control or communicate with the automated picker to travel to the designated compartment.

The racking structure controller (which may also be in the form of the individual bin handling apparatus controllers) may store, receive or retrieve information relating to where bins are located within the racking structure, such as which designated compartment or where the bin is positioned within the designated compartment. The racking structure controller 107 may also know the location of compartments within the overall racking structure.

The racking structure controller 107 may then communicate with the bin handling controller of the designated compartment to position the requested bin at an opening of the compartment for retrieval by the automated picker or to position a slot at an opening of the compartment for receiving a returned bin from the automated picker. In some embodiments, the bin handling apparatus may pass the requested bin to the automated picker or place the bin onto the automated picker. In other embodiments, the bin handling apparatus may retrieve the returned bin from a platform of the automated picker. Different methods of transferring a bin between the automated picker and the bin handling apparatus are contemplated. As discussed above, each compartment or bin handling apparatus 110 may have a bin handling controller 109 that communicates with the tacking structure controller 107, the warehousing controller 108, or both. In some embodiment, the bin handling controller 109 may store or retrieve information associated with a position of each of the at least two bins within its associated compartment and may control the bin handler to position bins or slots within the compartment as required.

Once the requested bin has been placed at the opening of the compartment or a slot for receiving the returned bin has been placed at the opening of the compartment, the automated picker may perform the requested task (1204) and may then return to its initial position. Retrieval/storage of the bin within the compartment is discussed in more detail below.

In another example of the method, as schematically shown in FIG. 12b, the system receives a request for an item or a bin that stores an item (1210), referred to as the requested bin. It is understood that the request may also be for the return of a bin to the racking structure. In one embodiment, the request may be received by the warehousing controller via input from a user, such as via a graphical user interface. Alternatively, the request may be received wirelessly by the warehousing controller by an external communication device, such as a Smartphone, a tablet, a laptop and the like.

Upon receipt of the request, the system determines a location (or racking structure) of the requested bin within the warehouse (1212). This location may be seen as the designated compartment. In one embodiment, this information may be retrieved via a database that stores item and/or bin location information within the warehouse. Alternatively, the warehousing controller may transmit a request to each racking structure controller to determine the racking structure within which the requested item is located.

After determining the location, a signal is transmitted to the racking structure controller where the item is located to position the bin holding the item to an opening of the compartment (1214). Concurrently, a signal is transmitted to the automated picker to retrieve the item from the determined location (1216).

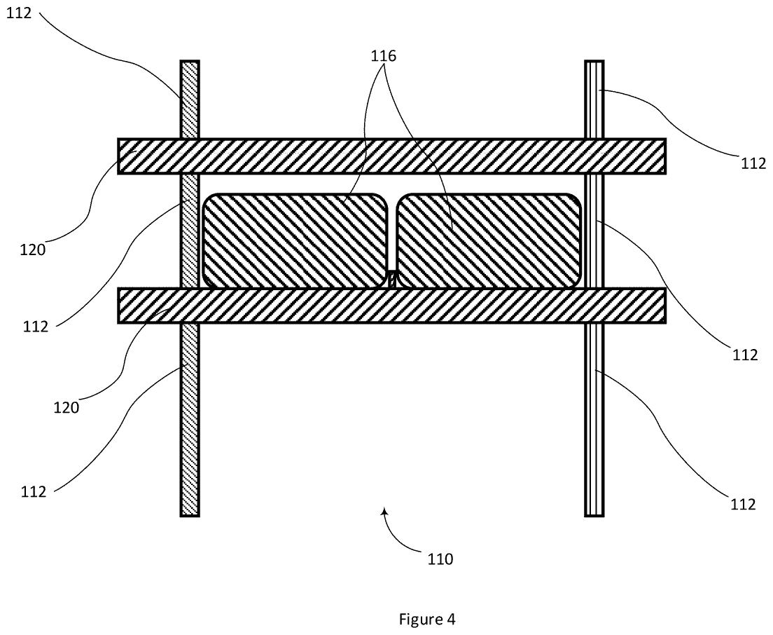

Upon receipt of the signal (1214) at the racking structure controller, the racking structure controller causes the bin associated with the item to be positioned in an opening of its compartment (1218). In one embodiment, a signal is transmitted to the compartment, or bin handling apparatus, controller 109 indicating which bin should be positioned in the opening. The bin handling controller then controls the bin handling apparatus to position the bin in the opening such as discussed below with respect to FIGS. 4 to 6. As the bin handling controller knows where the requested bin is located within the compartment with respect to the opening (or can retrieve such information), the bin handling apparatus can then be controlled to position the bin accordingly.

Once positioned in the opening, the bin may be retrieved by the automated picker once it arrives at the opening of the designated compartment (1220). As will be understood, in another embodiment, if a bin is being returned to the compartment, the bin handling controller may control the bin handling apparatus to position an open slot at the opening such that the automated picker can place the bin in the open slot of the bin handling apparatus can retrieve the bin from the automated picker.

After the bin is retrieved or received, updated bin information is transmitted to the bin handling controller so that this information is stored for future use when the bin is requested in the future. The bin handling controller may then transmit this updated bin information to at least one of the racking structure controller or the warehousing controller and/or may store this information in a database that is accessible by at least one of the compartment controller and the warehousing controller.

Although the retrieval and return of bins have been specifically taught in FIGS. 12a and 12b, it is understood that the same process may be applied to the retrieval of one or more items from a bin or return of one or more items to a bin.

In other embodiments, the warehousing controller 108 stores the location of each bin (or the designated compartment) with respect to the dynamic racking structure 100 and transmits instructions to the racking structure controller 107 having the designated compartment or the requested bin with this information. In some other embodiments, the warehousing controller 108 may communicate with the racking structure controller 107 to determine where a requested bin is located within a dynamic racking structure 100 (i.e. the designated compartment) whereby the racking structure controller 107 provides the designated compartment information to the automatic picker. In yet other embodiments, each racking structure controller 107 stores the location of each bin within its respective dynamic racking structure 100. In yet another embodiment, the warehousing controller 108 transmits instructions to all of the racking structure controllers 107 (assuming multiple high-density racking structures are located within the warehouse) to determine a location of the requested bin (or designated compartment). In this embodiment, the racking structure controller 107 of the dynamic racking structure containing the bin or designated compartment may provide this information to the warehousing controller 108 or may transmit instructions to the automated picker and/or bin handling apparatus to respond accordingly. In other embodiments, the warehousing controller 108 may communicate with a racking structure 107 to determine which compartments within the associated high-density racking structure have space for receiving a bin that is being returned (the compartment not necessarily being the compartment from which the bin was initially retrieved) and that compartment location (the designated compartment location) is then transmitted to the automated picker which then travels with the bin to the new designated compartment to return the bin to the dynamic racking structure.

While the operation of the dynamic racking structure 100 and the automated picker 114 have been discussed above in the context of retrieving a requested bin, the dynamic racking structure 100 may also be operated to store bins in a similar manner. It is understood that the system for retrieving and storing items within a high-density racking structure in a warehouse may include more than one dynamic high-density racking structure.

In other embodiment, such as when a bin is being returned to a designated compartment, a signal is transmitted from the warehousing controller 108 to the racking structure controller 107 requesting information relating to which compartments have space available to store the bin being returned. Alternatively, the warehousing controller 108 may have access to location and capacity information relating to each compartment or bin handler and may transmit a signal to the racking structure controller and/or the bin handling controller 109 which has space to receive a bin. The signal may include instructions to arrange the bins currently in the compartment or bin handling apparatus to position a slot at the opening of the compartment so that another bin can placed into the compartment or bin handling apparatus by the automated picker. After determining the location of the designated compartment, this information is transmitted to the picker so that the picker can store the bin. After storing the returned bin, a database maybe updated to reflect this new location information or each of the different controllers may be passed this location information for storage.

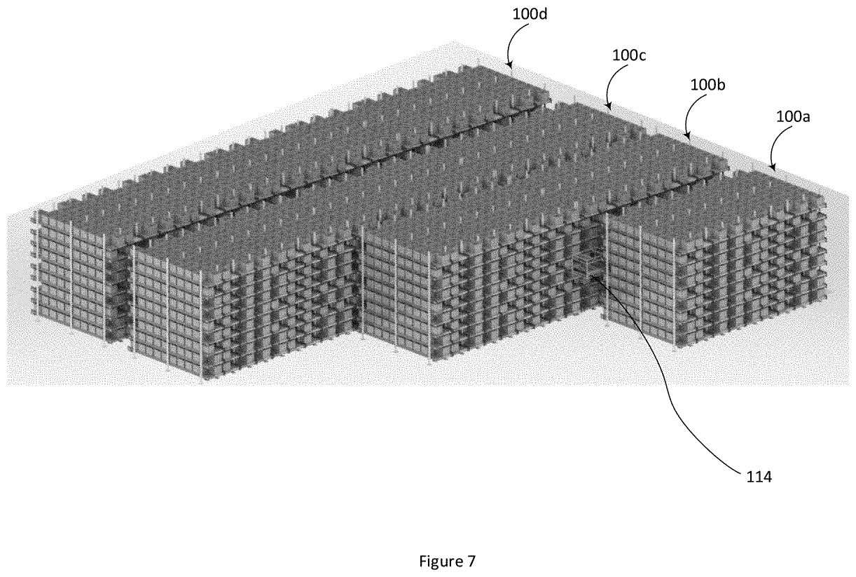

FIG. 4 is a cross-sectional view of a compartment 110 along plane A of FIG. 2. FIG. 5 is a front perspective view of a compartment 110 and bin handling apparatus according to an embodiment herein. FIG. 6 is a front perspective view of an automated picker. As discussed above, the compartment 110 is shaped and dimensioned to store a set of at least two bins 106 such that the racking structure may be seen as a high density racking structure. In the current embodiment, each compartment stores eighteen (18) bins.

Within each compartment, the at least two bins 106 may store the same items or they may store different items. In other embodiments, some of the bins 106 may store the same items and others of the set of bins may store one or more other items. Although the bins are shown in a two-dimensional array in the current embodiment, their arrangement may be in any type of shape or array depending on the size of the compartment. In some embodiments, the position of individual bins within a compartment is known by the racking structure controller 107 and/or the bin handling controller 109 and may be known by the warehousing controller 108. This information is used for positioning a selected bin within a compartment such that the automated picker can access the bin when needed.

It is assumed that the compartment of FIG. 5 includes a requested bin 118 or that a bin is being returned to the compartment. In the following description, use of the phrase retrieval of a bin from the compartment will also include the return of a bin to the compartment.

The compartment 110 includes a bin handling apparatus that includes a conveyor element 120, such as a conveyor system, to reposition the set of bins 116 within the compartment such that the requested bin 118 is positioned in the opening for access by the automated picker.

In the current embodiment, the conveyor element 120 includes two conveyors 122a and 122b and a set of lateral adjusters 124. In the current embodiment, there are four lateral adjusters with one not shown. It is understood that any number of conveyors and adjusters are contemplated and the design is system specific.

In the current embodiment, the conveyors 122 are positioned parallel to one another and are configured to convey any bins resting thereupon in opposite directions. The four lateral adjusters, or pushers, 124 are arranged in pairs at opposite ends of the conveyors 122 and are positioned to push a bin from one of the conveyors 122a to the other conveyor 122b such that the motion of travel of the bins may be seen as being in a somewhat circular motion. As understood, this may be performed in either a clockwise or counter-clockwise direction. In some embodiments, the bin handling controller 109 may determine which direction the bins should travel based on the location of the requested bin with respect to the opening. At least one end (seen as the opening) of the compartment 110 is accessible to the automated picker 114 such that the requested bin may be passed to or picked up by the picker 114 when in the opening. The conveyor element 120 is therefore configured to cycle the set of bins 106 past the opening of the compartment 110 until the requested bin is in the opening and thereby accessible to the automated picker 114. The cycling of the set of bins 106 by the bin handler 110 occurs independently of the cycling of bins in other compartments within the racking structure. In this manner, while the automated picker is retrieving a bin from one compartment, other bin handlers in other compartments may be positioning other requested bins for the automated picker to retrieve.

Depending on a design of the system, the compartment 110 may have openings on opposite ends that are serviced by separate automated pickers. In this case, the set of bins may be cycled in a direction that moves the requested bin towards the nearest opening to present the requested bin to the nearest automated picker thereby reducing the amount of time needed to cycle the set of bins and potentially increasing throughput.

The storage capacity of the compartment 110 may depend on the length of the compartment 110 in a direction parallel to the conveyors 120. In other words, the storage capacity of the compartment 110 may be scaled with the size of the compartment 110. Increasing the storage capacity of the dynamic racking structure 100 by increasing the length of the compartments 110 increases the space efficiency of the dynamic racking structure 100, since the number of items (or bins) that may be stored increases without requiring additional space to accommodate additional automated pickers 114.

In experiments, increasing the storage capacity of the dynamic racking structure 100 by increasing the length of the compartments 110 or bin handling apparatus does not appear to have an effect on the throughput of the dynamic racking structure 100. While a greater number of bins making up the set of bins 116 may take longer to cycle through (depending on the position of the requested bin), the process of cycling the set of bins 116 can occur while the automated picker is occupied picking up bins from other compartments. In this manner, the automated picker may pick up more than one bin or item during a single trip. In this embodiment, the controller controlling the automated picker may transmit a picking queue to the automated picker. The picking queue may be adjusted to reduce the time to retrieve bins or items from the high-density racking structure. In other words, by understanding or knowing a position of requested bins within their associated compartments, a picking queue order for bin retrieval may be determined based on compartment location and requested bin location within that compartment. For requested bins that are located at an end opposite the opening (assuming a single compartment opening), these requested bins may be placed later in the picking queue as it would take longer for the bin handling apparatus to move the requested bin from its location to the opening. Similarly, for requested bins that are located proximate or near the opening, they may be retrieve earlier in the picking queue since it will not take as much time for the bin to be positioned in the opening. This may reduce the idling time for automated pickers.

Additionally, as outlined above, the direction of travel of the conveyors 122a and 122 may be multi-directional or reversible and may cooperate with the pushers 124 to cycle the set of bins 106 in either a clockwise or a counter-clockwise direction relative to the orientation of the compartment 110. This allows a cycling direction to be chosen that reduces or minimizes the cycling time of the set of bins 116 further improving the throughput of the dynamic racking structure 100.

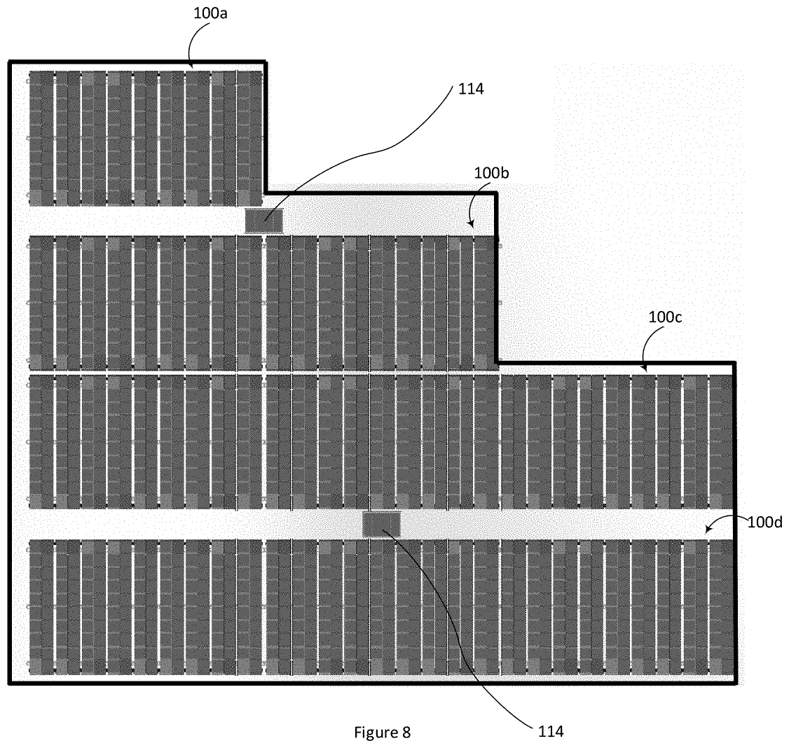

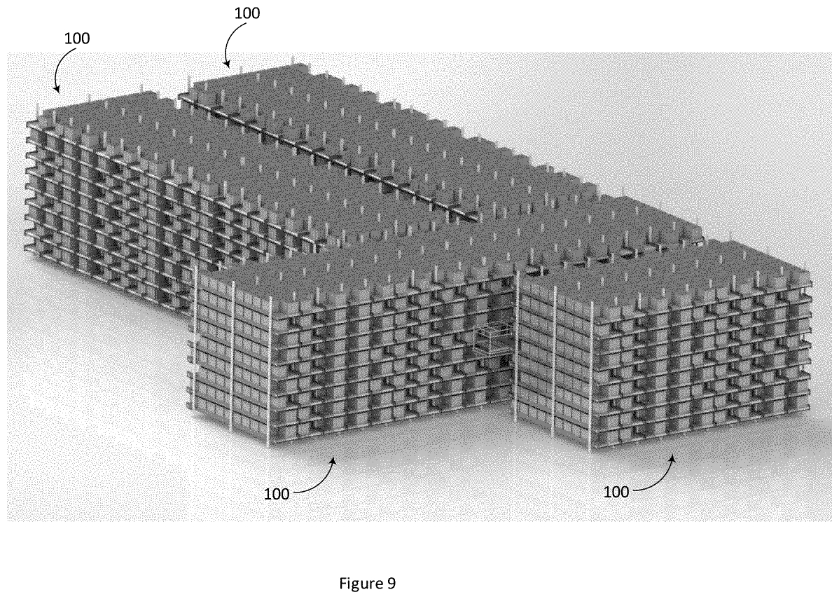

In some embodiments, pairs of dynamic racking structures 100 may be arranged with an automated picker positioned therebetween and multiple pairs of dynamic racking structures may be positioned to form an arrangement of dynamic racking structures 100. FIG. 7 is a front perspective view and FIG. 8 is a top view of one arrangement of dynamic racking structures 100. The arrangement of dynamic racking structures 100 includes dynamic racking structures 100a, 100b, 100c, and 100d. Dynamic racking structures 100a and 100b are positioned parallel to one another with an automated picker 114 positioned therebetween that is positioned to pick, or retrieve, from either dynamic racking structure 100a or dynamic racking structure 100b, even though dynamic racking structures 100a and 100b have differing lengths. Likewise, dynamic racking structures 100c and 100d are positioned parallel to one another with another automated picker 114 positioned therebetween while having the same length. In some embodiments, there may be an automated picker positioned between dynamic structures 100b and 100c.

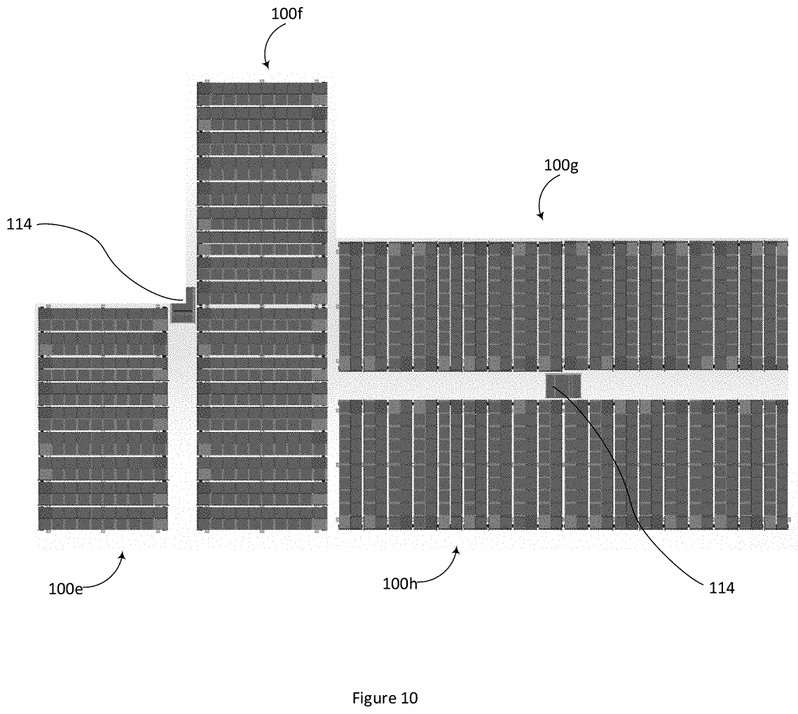

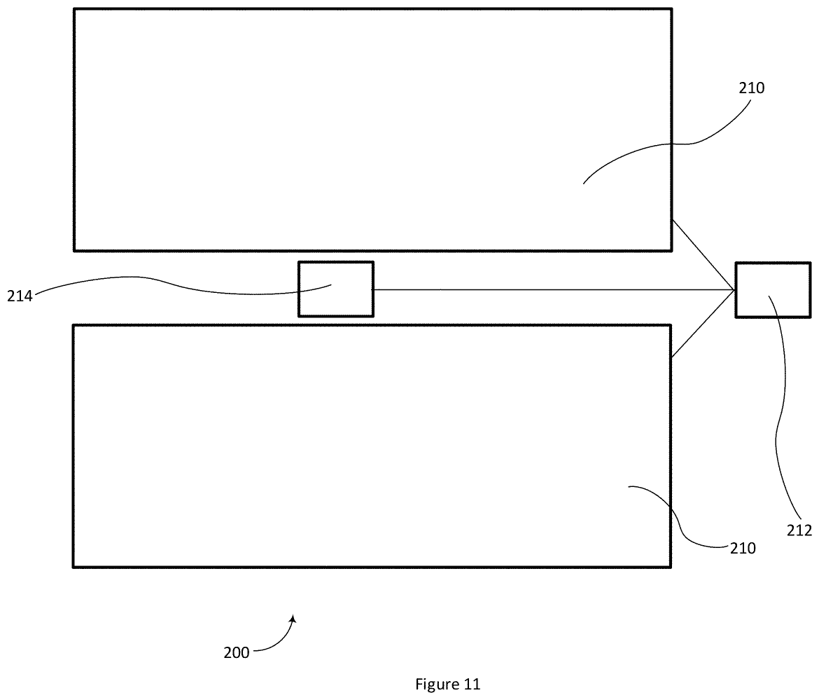

FIG. 9 is a front perspective view, and FIG. 10 is a top view of another arrangement of dynamic racking structures. The arrangement of FIGS. 9 and 10 is somewhat similar to the arrangement of dynamic racking structures of FIGS. 7 and 8 except that some dynamic racking structures 100e and 100f are oriented perpendicular to other dynamic racking structures 100g and 100h within the arrangement. The position and orientation of dynamic racking structures 100 within a warehouse is therefore not limited to a single orientation of dynamic racking structures, and instead may be modified or adapted to suit a variety of floorplans, layouts or shapes of warehouses or warehouse buildings.

In one embodiment, the conveyor element 120 may be a chain conveyor, a pusher, or the like. In another embodiment, the dynamic racking structure 100 may use an automated picker moveable by pulleys, rollers, pistons, or the like.

In another embodiment, the dynamic racking structure 100 does not use an automated picker. For example, each shelf 102 may include a horizontal conveyor where each compartment may include an additional pusher to transfer bins between the horizontal conveyor and each compartment. Vertical lifts (located at ends of the dynamic structure) may then transfer bins in a vertical direction for manual retrieval or for retrieval by other machinery at floor level. In this way, the horizontal and vertical motion of the automated picker is divided into independent systems, which may increase throughput.

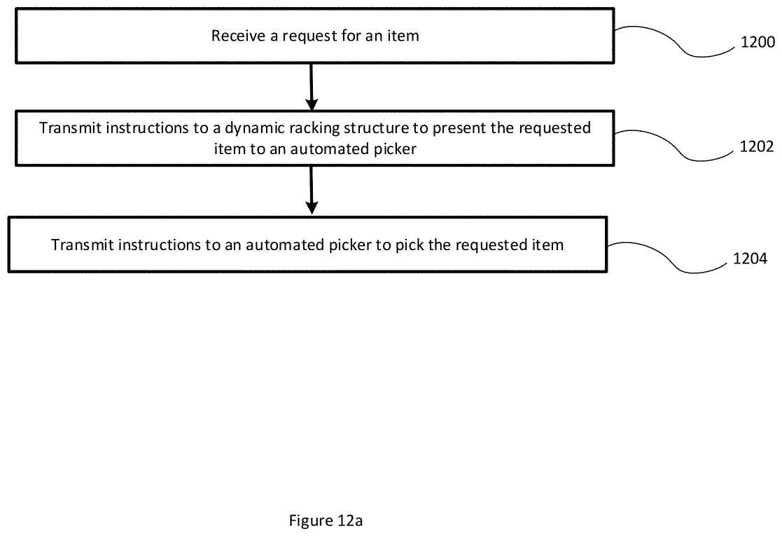

FIG. 11 is a schematic diagram of another embodiment of a high density warehousing arrangement 200. In the current arrangement, warehousing system 200 includes dynamic racking structures 210, a controller 212, and automated picker 214. Controller 212 is communicatively coupled to dynamic racking structures 210 and automated picker 214 such as discussed above. Controller 212 (which may be seen as one or a combination of the warehousing controller, the racking structure controller and/or bin handling controller described above) is configured to receive a request for an item or bin, to transmit instructions to a dynamic racking structure 210 to present the requested item in an opening of a designated compartment and to the automated picker 214 to pick or retrieve the requested item. In one embodiment, controller 212 is configured to place the request for an item in a request queue, and to transmit the instructions to position the requested items or bins in the opening of the compartment prior to transmitting the instructions to pick the requested item.

In order to improve throughput, controller 212 may be configured to determine a location of the requested item within a dynamic racking structure 210; configured to determine a cycling time of the dynamic structure 210 necessary to present the requested item; configured to determine an expected time necessary to complete each picking operation currently present in the picking queue and/or configured to place the request within the picking queue such that the cycling time is greater than the sum of the picking operations ahead of the requested item in the picking queue.

While various embodiments have been described above, it should be understood that they have been presented only as illustrations and examples of the present disclosure, and not by way of limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments but should be defined only in accordance with the appended claims and their equivalents. It will also be understood that each feature of each embodiment discussed herein, and of each reference cited herein, can be used in combination with the features of any other embodiment.

What is claimed:

1. A high-density warehousing system comprising:
a set of high-density racking structures, each of the high-density racking structures including a set of compartments for housing a set of bins;
an automated picker for retrieving a requested bin or returning a returned bin to a designated compartment within the set of high-density racking structures;
a control system for communicating compartment location information, the compartment location information associated with the designated compartment;
wherein based on the compartment location information, the automated picker retrieves or returns the bin to the designated compartment.

2. The high-density warehousing system of claim 1 wherein the control system comprises:
an automated picker controller for communicating with the automated picker; and
a bin location controller.

3. The high-density warehousing system of claim 2 wherein the compartment location information is transmitted via the automated picker controller to the automated picker.

4. The high-density warehousing system of claim 3 wherein each of the set of compartments comprises a bin handling system for changing positions of bins within the compartment and a bin handling system controller.

5. The high-density warehousing system of claim 4 wherein the bin location controller transmits bin information associated with the requested bin or the returned bin to the bin handling system controller.

6. The high-density warehousing system of claim 5 wherein the bin handling system controller controls the bin handling system to position the requested bin at an opening of the designated compartment for retrieval by the automated picker or to position an empty slot at the opening of the designated compartment for receiving the returned bin from the automated picker.

7. The high-density warehousing system of claim 3 wherein each of the set of compartments comprises a bin handling system for changing positions of bins within the compartment.

8. The high-density warehousing system of claim 7 wherein each of the set of racking structures comprises a racking structure controller.

9. The high-density warehousing system of claim 8 wherein the bin location controller transmits bin information associated with the requested bin or the returned bin to the bin racking structure controller.

10. The high-density warehousing system of claim 9 wherein the racking structure controller controls the bin handling system of the designated compartment to position the requested bin at an opening of the designated compartment for retrieval by the automated picker or to position an empty slot at the opening of the designated compartment for receiving the returned bin from the automated picker.
